(19) United States
(12) Patent Application Publication
(10) Pub. No.: US 2026/0307039 A1
(43) Pub. Date: Oct. 8, 2026

(54) EXPANDABLE CATALYST SUPPORT CONFIGURATION

(71) Applicant: Johnson Matthey Davy Technologies Limited, London (GB)

(72) Inventors: Gordon Wayne BRUNSON, Savannah, GA (US); Joshua Michael CAGLE, Savannah, GA (US)

(21) Appl. No.: 19/480,213

(22) PCT Filed: May 23, 2024
(86) PCT No.: PCT/EP2024/064289

§ 371 Date: Oct. 30, 2025

Related U.S. Application Data
(60) Provisional application No. 63/504,017, filed on May 24, 2023.

(51) Int. Cl. B01J 19/32

(52) U.S. Cl. CPC B01J 19/32; B01J 2219/30292; B01J 2219/30408

(57) ABSTRACT

An expandable catalyst support configuration for a reactor, the expandable catalyst support configuration comprising: an expansion tube; and an expandable catalyst support surrounding the expansion tube, wherein the expansion tube is in the form of a spiral-wound tube which is configured to push the expandable catalyst support outwards when it unfurls during installation of the expandable catalyst support configuration in the reactor, and wherein the spiral-wound tube is formed of a spiral-wound metal sheet having surface areas which contact and slide over each other during unfurling, and wherein at least a portion of the surface areas have a roughened matte finish to facilitate unfurling of the spiral-wound metal sheet.

### FIELD

The present specification relates to an expandable catalyst support configuration for a reactor, to a reactor including the expandable catalyst support configuration, and to a method of installing the expandable catalyst support configuration in the reactor. The present specification also relates to an expandable catalyst substrate support component for a reactor, within a reformer, including the expandable catalyst substrate support configuration. In particular, but not exclusively, the present specification relates to reactors known as stackable structured reactors (SSRs).

### BACKGROUND

Reactor components for carrying out catalytic reactions, such as those used to produce syngas or hydrogen, can generally contact reactor tubes exposed to a heat source/heat element, for example a furnace, to support reactions. In contrast, other types of reactions, such as exothermic reactions, can require a cooling source, such as a cooling jacket. The reactor tubes can be loaded with various arrangements of catalyst-coated components, such as foil-supported or structured catalysts in the form of fans, fins, coils, foams, monoliths, or any other formed substrate. In some instances, the reactor catalyst-coated components can be expandable, such as those formed from foil, for example, a fan.

To improve heat transfer and fluid flow through a reactor, the fit of foil-supported catalysts can be enhanced. In a reactor tube, expandable catalyst-coated reactor components can be positioned to increase heat transfer, such as being in contact with or in a controlled proximity to the reactor wall exposed to a heating or cooling source. Thus, it is desirable to fit reactors with accessories to promote increased heat transfer and reactor efficiency.

WO2013151889 describes an expandable centre arrangement for use in a tubular reactor, such as a reformer, for enhancing heat transfer and reactor efficiency. The expandable centre arrangement can include a cone being expandable in the radial direction and an expansion weight for promoting expansion of the cone. The cone and expansion weight can be slidable arranged on a centre support. Expansion of the cones in the radial direction forces reactor catalyst-coated components radially outward to an outer tube that houses the reactor catalyst-coated components and expandable centre arrangement. Expansion of reactor catalyst-coated components towards the outer tube promotes heat transfer for carrying out catalytic reactions.

The arrangement in WO2013151889 produces good performance but involves relatively expensive sliding bushings and expanding cones. The cones may be expensive or have reliability issues. The push-nuts used to hold the cones and bushings in place can be awkward to install and may require a special surface on the centre support. To install the system, a tool with three functions is required: grab; blast; and push. There is therefore room for improvement of the system of WO2013151889, in particular to further lower the system cost and further improve the ease of installation of the system.

WO2017205359 describes an alternative configuration providing an expandable centre arrangement for a reactor, the arrangement comprising: an expansion tube; a centre support inside the expansion tube and three or more spring elements; the spring elements being fastened to the centre support and arcing out to the expansion tube. It is described that such an arrangement may provide an expandable centre that provides an expansive force to the structured catalyst-coated components of the reactor, while not requiring a large number of separate moving parts. The arrangement is thus advantageously straightforward to manufacture, assemble and install and may provide potential for cost savings. The spring elements are preferably resilient so as to bias the expansion tube outwardly away from the centre support.

An aim of the present specification is to provide an improved expandable catalyst support configuration for a reactor and particularly one which is simple in construction while also being reliable in expansion performance during installation providing high pressure gradients and high pull-out force.

### SUMMARY

The present specification is directed to an expandable catalyst support configuration for a reactor, the expandable catalyst support configuration comprising: an expansion tube; and an expandable catalyst support surrounding the expansion tube, wherein the expansion tube is in the form of a spiral-wound tube which is configured to push the expandable catalyst support outwards when it unfurls during installation of the expandable catalyst support configuration in the reactor.

The expandable catalyst support configuration is introduced into an outer tube within a reactor during installation. The spiral-wound tube is formed of a spiral-wound metal sheet having surface areas which contact and slide over each other during unfurling and expansion to push the expandable catalyst support outwards towards the outer tube wall of the reactor in which the expandable catalyst support configuration is disposed. By expanding to the outer tube wall, high pressure gradients and high pull-out forces can be achieved.

The present specification is particularly concerned with enhancing/improving the expansion of the expandable catalyst support configuration during installation to make it easier to install the catalyst support configuration and ensure high pressure gradients and pull-out forces are achieved. In this regard, the expansion tube material typically has a smooth, bright-annealed surface finish. It has been found that processing the smooth, bright-annealed surface of the expansion tube material to create a matte finish on the expansion tube material (e.g., via sanding or other means) facilitates unfurling of the spiral-wound metal sheet, making it easier to install the expandable catalyst support configuration to ensure high pressure gradients and pull-out forces are achieved.

### BRIEF DESCRIPTION OF THE DRAWINGS

For a better understanding of the present invention and to show how the same may be carried into effect, certain embodiments of the present invention will now be described by way of example only with reference to the accompanying drawings, in which:

FIG. 1 shows a schematic diagram of an expandable catalyst support configuration comprising an expansion tube/sleeve and an expandable catalyst support surrounding the expansion tube, the configuration being mounted in an outer tube within a reactor;

FIG. 2 shows a photograph of the test fixture to gage expansion sleeve material friction;

FIG. 3 shows photographs of a sample pair of bright-annealed foils after testing as-used in current expansion sleeves (left=top foil; right=bottom foil) which exhibit scratches with “nuggets” at end of scratches;

FIG. 4 shows a photograph of an expansion sleeve after an install-test showing the same deeply fretted scratches;

FIG. 5 shows photographs of a sample-pair after testing where both foils were sanded with 80-grit paper (left=top foil; right=bottom foil) noting that scratches are now typically only very light and narrow;

FIG. 6 shows photographs of a sample after testing where the bottom foil (only) was sanded with 80-grit paper (left=top as-milled foil; right=bottom sanded foil) noting that scratches are also now only narrow;

FIG. 7 shows a graph illustrating the breakaway force from baseline bright-annealed samples (no prep) and sanded samples noting that samples which have been sanded show a significant reduction in static friction force with samples sanded on both surfaces exhibiting the lowest static friction force;

FIG. 8 shows photographs of a sample-pair where both foils were press-embossed with 80-grit sandpaper (left=top foil, bosses point into page; right=bottom foil, bosses point out of page) noting that some nuggets form on tops of bosses (right) and produce scratches on the foil opposite (left);

FIG. 9 shows a graph illustrating the breakaway force from baseline bright-annealed samples (no prep) and embossed samples (hammered or pressed) noting that samples which have been embossed show a significant reduction in static friction force;

FIG. 10 shows a graph illustrating the magnitude and variation of breakaway force for different foil preparations noting that sanding and embossing both reduce the magnitude of the breakaway force although the variation in samples was larger for embossing compared to sanding; and

FIG. 11 shows a graph illustrating pressure gradient and pull-out force testing results indicating that expansion sleeve texturing consistently resulted in stacks with higher pressure gradient and pull-out force in use after expansion.

### DETAILED DESCRIPTION

The expansion tube/sleeve of a stackable structured reactor (SSR) stack is made of metal foil and is in the form of a spiral-wound tube. During the expansion (installation) process, the expansion tube is pumped with a burst of compressed air. The expansion tube subsequently expands by unfurling and pushes the surrounding SSR fans outward toward the reactor/reformer tube's inner diameter. However, the smooth, bright-annealed expansion tube material (as supplied by the metal sheet/foil manufacturer, e.g. Fecralloy™) is susceptible to a cold-welding process as it unfurls (e.g., as Fecralloy™ slides across Fecralloy™). This can inhibit the process of expansion. Processing the smooth, bright-annealed surface of the expansion tube material to create a matte finish on the expansion tube material (via sanding or other means) facilitates unfurling of the spiral-wound metal sheet, making it easier to install the expandable catalyst support configuration to ensure high pressure gradients and pull-out forces are achieved.

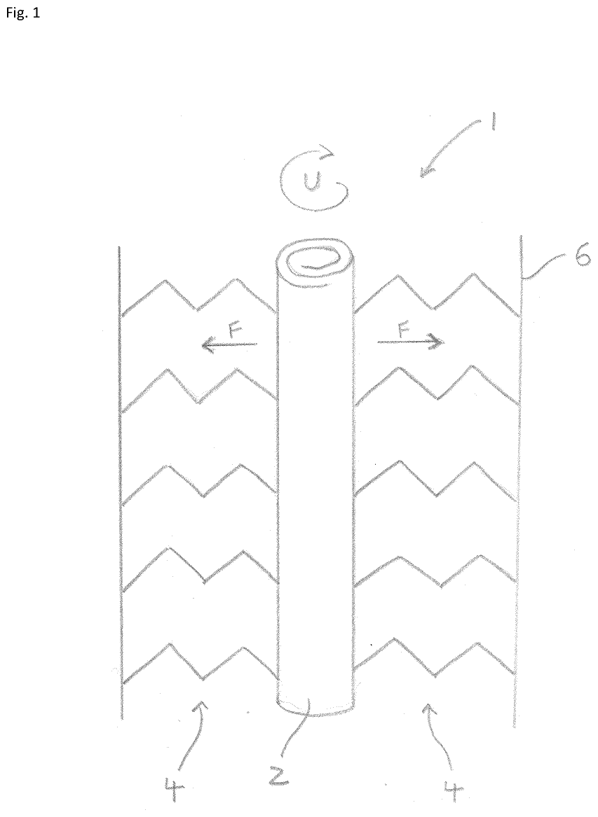

As shown in FIG. 1, the present specification provides an expandable catalyst support configuration 1 for a reactor. The expandable catalyst support configuration 1 comprises an expansion tube 2 and an expandable catalyst support 4 surrounding the expansion tube 2. The expansion tube 2 is in the form of a spiral-wound tube which is configured to push the expandable catalyst support outwards (“F” when it unfurls (“U”) during installation of the expandable catalyst support configuration in a tube 6 of a reactor. The spiral-wound tube 2 is formed of a spiral-wound metal sheet having surface areas which contact and slide over each other during unfurling. At least a portion of the surface areas have a roughened matte finish (i.e., not a bright-annealed surface finish) to facilitate unfurling of the spiral-wound metal sheet (i.e., to prevent cold-welding of the spiral-wound metal sheet inhibiting unfurling).

The spiral-wound metal sheet can be formed of a metal alloy comprising iron, chromium, and aluminium (e.g., Fecralloy™). Such metal alloys are suitable for use in reactor applications but have been found to have the expansion issue as described above. Commercially supplied materials have a bright-annealed surface finish and it has been found that this needs to be processed to roughen the surface in order to avoid expansion issues during installation. For high temperature applications, the spiral-wound metal sheet can be formed of a metal alloy selected from the group consisting of Inconel alloys, Fecralloy, alloy 800, INVAR, Hastelloy, and 316 stainless steel. For lower temperature applications a large variety of stainless steels could optionally be used.

The surface areas having the roughened matte finish may have a surface roughness (Ra) of: at least 8, 12, 16, 20, 24, 28, 32, 36, or 40 μpin (i.e., at least 0.2, 0.3, 0.4, 0.5, 0.6, 0.7, 0.8, 0.9, or 0.10 μm); no more than 2000, 1000, or 500 μpin (i.e., no more than 50, 25, or 12.5 μm), or within a range defined by any combination of the aforementioned lower and upper limits.

Furthermore, the metal sheet having the roughened matte finish can have a static friction force of no more than 2 lbf, 1.75 lbf, 1.5 lbf, or 1.3 lbf. The spiral-wound metal sheet may have the roughened matte finish on one or both sides thereof. Preferably an area of at least 50%, 75%, 90%, or 99% of one or both sides of the spiral-wound metal sheet have the roughened matte finish.

The present specification also provides a reactor comprising: an outer tube 6; and an expandable catalyst support configuration 1 as described above which is disposed within the outer tube 6, wherein the expansion tube 2 having the roughened matte finish biases the expandable catalyst support 4 towards the outer tube (reference numerals as shown in FIG. 1).

Improved expansion through the provision of an expansion tube with a roughened matte surface increases the pressure gradient across the expandable catalyst support configuration when installed in the reactor. As such, the reactor is configured to operate with a pressure gradient across the expandable catalyst support configuration of: at least 1.4 mbar/in, 1.5 mbar/in, 1.6 mbar/in, or 1.7 mbar; no more than 5 mbar/in, 3 mbar/in, 2 mbar/in, or 1.8 mbar/in; or within a range defined by any combination of the aforementioned lower and upper limits.

Improved expansion through the provision of an expansion tube with a roughened matte surface also increases the static pull-out force of the expandable catalyst support configuration when installed in the reactor. As such, the reactor is configured such that the expandable catalyst support configuration has a static pull-out force of: at least 100 lb, 150 lb, 200 lb, 250 lb, 350 lb, 400 lb, 450 lb, or 500 lb; no more than 1000 lb, 800 lb, 700 lb, 600 lb, 500 lb, 400 lb, 300 lb, or 250 lb; or within a range defined by any combination of the aforementioned lower and upper limits. For example, in certain configurations a target static pull-out force is in a range 150-250 lb. As such, a broader range of 100 to 1000 lb may be allowed for, optionally aiming to correct for examples outside 150-250 lb in testing.

The present specification also provides a method of installing an expandable catalyst support configuration as described herein into a reactor as described herein, the method comprising: inserting the expandable catalyst support configuration into the outer tube of the reactor; and pumping or blasting compressed gas into the expansion tube to unfurl the expansion tube pushing the expandable catalyst support outwards towards the outer tube.

### EXAMPLES

Prototype expansion sleeves with matte finishes have been made by lightly sanding the surface of bright-annealed sleeves, both one-sided and two-sided, using a random-orbital sander. Another method (used in bench-scale demonstrations) has been pressing the sleeve material against sandpaper to emboss the bright-annealed sleeve with the peaks from the sandpaper's grit. Another method (the most economical) would be to have the material supplier produce the material without a bright-annealed finish. While suppliers of other foil materials are able to provide either matte or bright finishes on their foils, the supplier of the preferred metal foil material for the expansion tube application only provides bright-annealed material at present.

### Expansion Sleeve Friction Evaluations

The sleeve material was evaluated in small friction tests. Foil coupons were stacked together, and a 2″×2″×2″ dead weight (mild steel) was stacked on the top foil. The top foil was then pulled (free hand) with a spring gage (maximum 4 lb), and the force necessary to make the foil “breakaway” (i.e., to start the top foil sliding) was measured. In these initial tests, no attention was paid to the orientation of the mill-grain or the stress-relief history of the foils.

Once the early tests showed promise, a small fixture was built to pull the foil samples more repeatably. The bottom foil was clamped into the fixture on a flat sheet of stainless steel (16-gauge); the top foil sample was laid down over it; and the dead weight was placed on the top foil. A crank (with a pull-cord) allowed controlled and repeatable tension on the top foil. The breakaway force was measured with the spring-scale. Several “breakaways” could be measured as a single sample-pair was pulled; the spring scale would reach breakaway and contract slightly, then tension would be relaxed, then tension would be increased to force the next breakaway. Each sample-pair was pulled through a test once, although several breakaways were recorded for each pair (as few as three, or as many as sixteen, depending on how far each sample slid after breakaway).

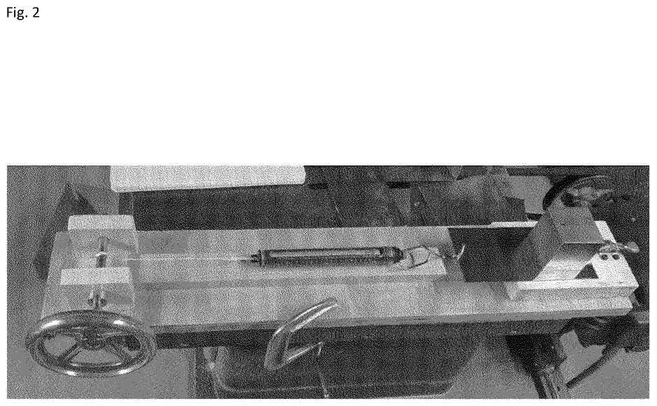

Foil samples were made from 3″ wide×0.004″ thick Fecralloy™ foil (expansion sleeve stock). The samples were heat treated at 480 °C for 1 hr, to mimic the process that regular sleeves go through. Care was taken to always orient the mill-grain of the foils cross-wise to the direction of pulling (the same grain-to-sliding orientation in the SSR during roll-up or expansion). Care was also taken to keep the samples clean (they were wiped with a paper towel before tests), and to keep edge-burrs from playing a part in the measurements (the dead weight was smaller than the foil samples). FIG. 2 shows a photograph of the test fixture to gage expansion sleeve material friction.

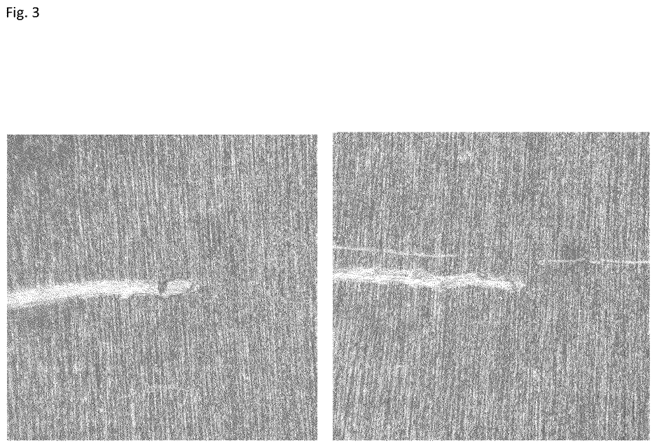

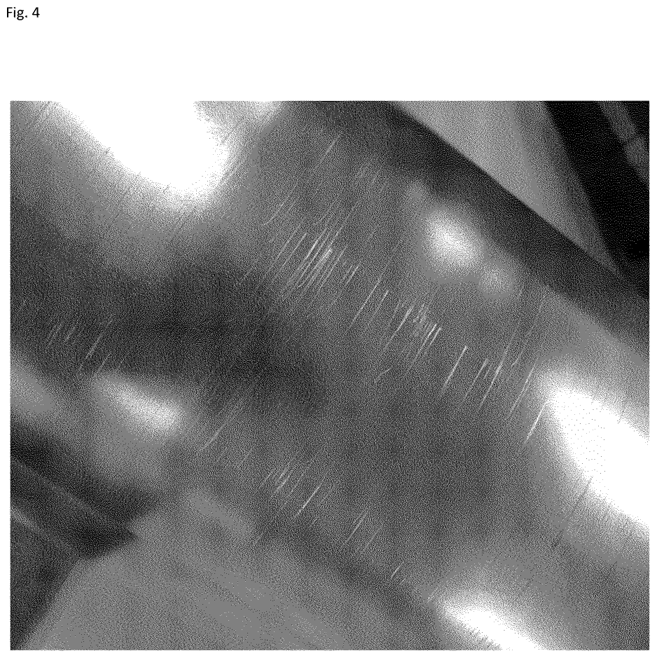

These tests revealed several things. First, fretting is a large contributor to the interleaf friction of the expansion sleeve. The fretting shows up as scratches (these are always seen in expansion sleeves after rollup or expansion) and can cause wide variability in friction. The deepest fretted scratches show “nuggets” of material at the ends, where Fecralloy material has clumped together as the scratch progresses. These same types of scratches can be seen on actual expansion sleeves after installation tests. FIG. 3 shows a sample pair of bright-annealed foil as-used in current expansion sleeves (left=top foil; right=bottom foil). Scratches are coincident on the two foils with “nuggets” at end of scratches. Note that the direction of sliding was perpendicular to the mill-grain of the foil. FIG. 4 shows an expansion sleeve after an install-test showing the same deeply fretted scratches.

The second revelation of the friction testing was that the fretting could be reduced (and almost eliminated) by texturing the milled surface of the foil. Different texturing methods were explored. First (in early freehand tests) both foil surfaces were sanded randomly with fine paper (320-grit). This eliminated the fretting entirely and lowered the breakaway force considerably. Later (in fixtured tests), to simulate a more viable production process, foils were sanded with coarse paper (80-grit) in a single direction aligned with the mill-grain. Samples were tested with one, then both, foil surfaces sanded. Sanding both surfaces again greatly reduced fretting and breakaway force. Sanding one surface (only) also reduced fretting and breakaway, but to a lesser degree. In both cases, the variability of breakaway force was reduced by sanding.

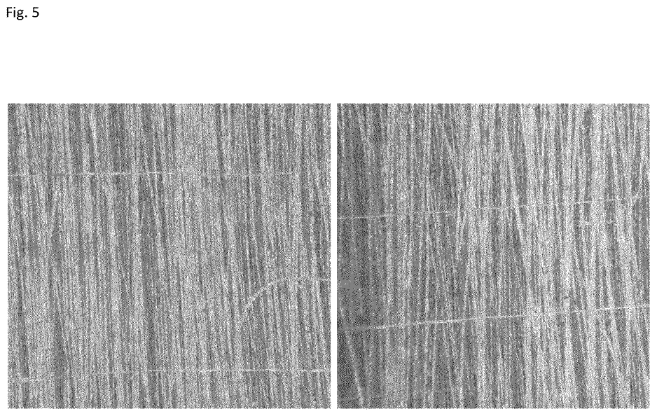

FIG. 5 shows a sample-pair after testing where both foils were sanded with 80-grit paper (left=top foil; right=bottom foil). Sanding-lines are vertical and friction test scratches are horizontal. The direction of sliding was perpendicular to direction of sanding. Note that scratches are typically very light and narrow.

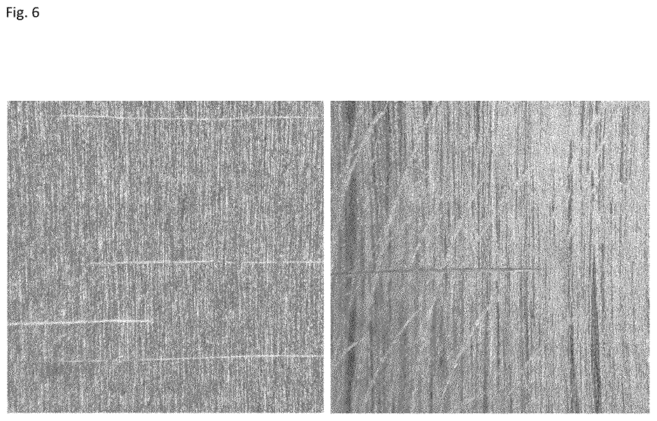

FIG. 6 shows a sample after testing where the bottom foil (only) was sanded with 80-grit paper (left =top foil (as-milled); right=bottom foil (sanded; sanding-lines are vertical)). The direction of sliding was perpendicular to direction of mill-grain/sanding. Note that scratches are narrow.

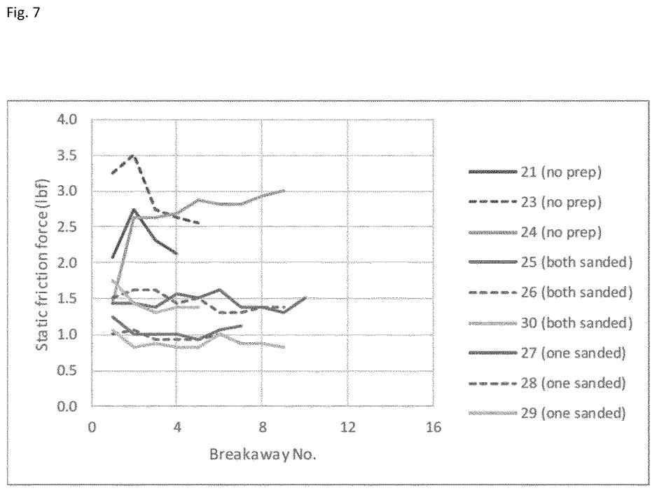

FIG. 7 shows a graph illustrating the breakaway force from baseline bright-annealed samples (no prep) and sanded samples. Samples which have been sanded show a significant reduction in static friction force with samples sanded on both surfaces exhibiting the lowest static friction force.

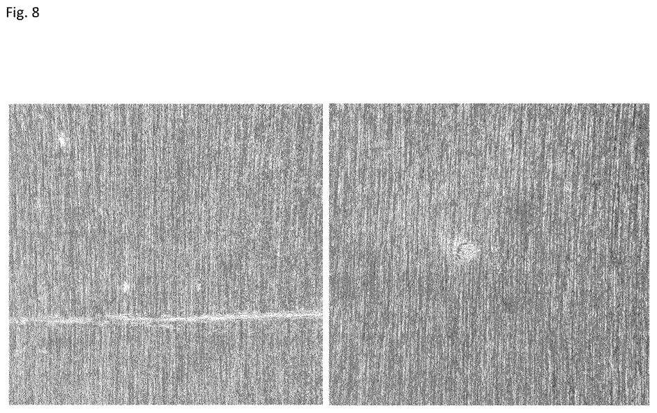

Lastly, foil samples were textured by embossing. In this case, coarse sandpaper (80-grit) was laid grit-side-up on a flat cast-iron surface, foil was placed over the sandpaper, and a ⅛″ thick layer of rubber (Viton™) was placed over the foil. The top of the rubber sheet was then pressed to emboss the roughness of the sandpaper into the foil. The first three samples were made by manually hammering the rubber-foil-sandpaper stack. Two final samples were made using a hydraulic press to evenly apply the embossing pressure-this was intended to simulate a feasible production process. Embossing samples reduced friction breakaway force (like sanded samples) but didn't seem to reduce the frictional variability as much as sanding had achieved. FIG. 8 shows a sample-pair where both foils were press-embossed with 80-grit sandpaper (left=top foil, bosses point into page; right=bottom foil, bosses point out of page). Nuggets form on tops of bosses (right) and produce scratches on the foil opposite (left). Note again that the direction of sliding in testing was perpendicular to direction of the mill-grain of the foils.

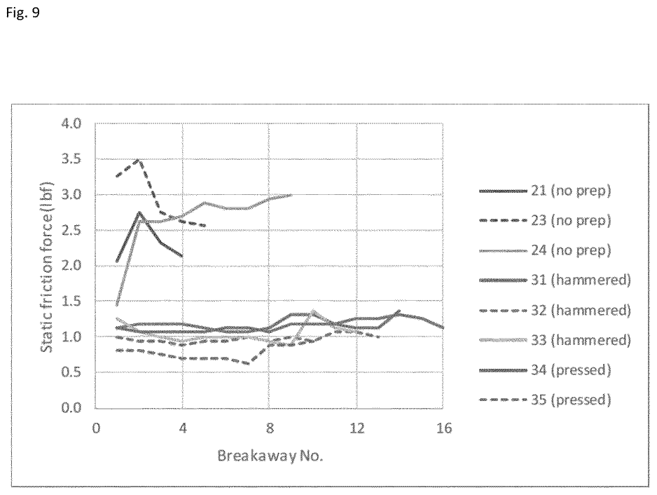

FIG. 9 shows a graph illustrating the breakaway force from baseline bright-annealed samples (no prep) and embossed samples (hammered or pressed). Samples which have been embossed show a significant reduction in static friction force.

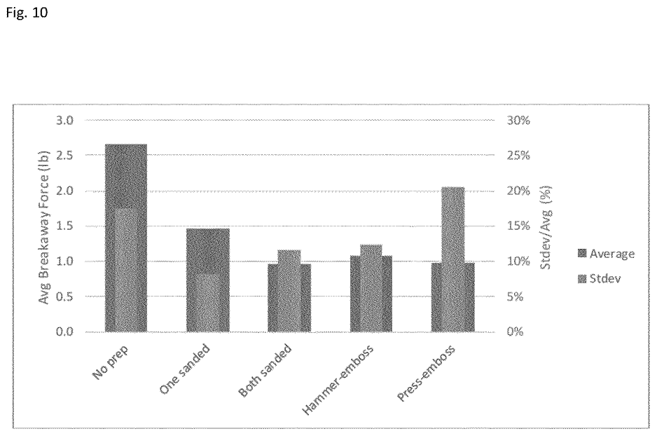

FIG. 10 shows a graph illustrating the magnitude and variation of breakaway force for different foil preparations. Sanding and embossing both reduce the magnitude of the breakaway force although the variation in samples was larger for embossing compared to sanding.

The test results indicate that the deeply fretted scratches and the observed ‘nuggets’ of the expansion sleeves are contributing to sleeves getting stuck after transport and storage, then refusing to expand. Processing the sleeves by sanding or embossing to create a matte surface finish can reduce or eliminate this issue. The “one-side-sanded” preparation may be the most favourable. The average friction is decreased from the baseline about 45%, but variability of friction (as a fraction of average friction) was cut by 53%. This could be implemented by sanding one side of the expansion sleeves in the same direction as the mill-grain. The lower friction (and lesser fretting) causes the sleeve to more easily contract after installation, but this can be compensated by rolling the sleeve to a larger diameter or lengthening the sleeve to add wrap-angle. The present specification enables better control of the sleeve's interleaf friction to a tighter tolerance and minimizes fretting.

### Pressure Gradient and Pull-Out Force Testing

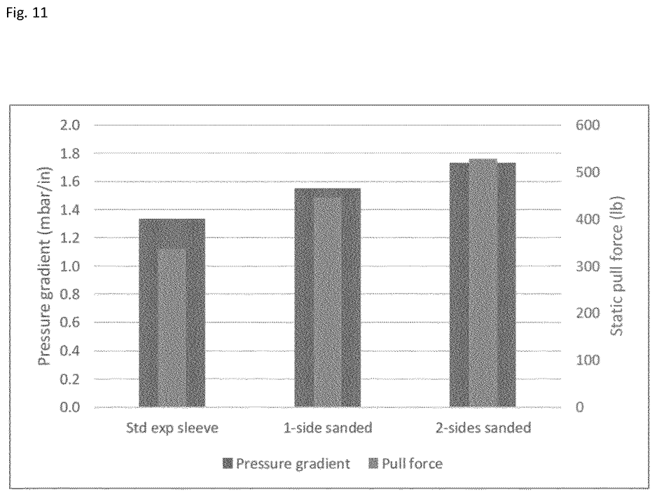

Expandable catalyst support configurations were prepared for pressure gradient and pull-out force testing. These test configurations included: fifteen control stacks (with standard, shiny expansion sleeves); fifteen stacks with 1-side sanded expansion sleeves; and fifteen stacks with 2-sides sanded expansion sleeves. With all other inputs held constant, the results (as shown in FIG. 11) indicated that expansion sleeve texturing consistently resulted in stacks with higher pressure gradient and pull-out force in use after expansion. From these results, it is inferred that expansion sleeve texturing will increase the reliability of expansions during an installation.

While this invention has been particularly shown and described with reference to certain examples, it will be understood to those skilled in the art that various changes in form and detail may be made without departing from the scope of the invention as defined by the appended claims.

1. An expandable catalyst support configuration for a reactor, the expandable catalyst support configuration comprising:
an expansion tube; and
an expandable catalyst support surrounding the expansion tube,
wherein the expansion tube is in the form of a spiral-wound tube which is configured to push the expandable catalyst support outwards when it unfurls during installation of the expandable catalyst support configuration in the reactor, and
wherein the spiral-wound tube is formed of a spiral-wound metal sheet having surface areas which contact and slide over each other during unfurling, and
wherein at least a portion of the surface areas have a roughened matte finish to facilitate unfurling of the spiral-wound metal sheet.

2. The expandable catalyst support configuration according to claim 1, wherein the spiral-wound metal sheet is formed of a metal alloy comprising iron, chromium, and aluminium.

3. The expandable catalyst support configuration according to claim 1, wherein the spiral-wound metal sheet is formed of a metal alloy selected from the group consisting of Inconel alloys, Fecralloy, alloy 800, INVAR, Hastelloy, and 316 stainless steel.

4. The expandable catalyst support configuration according claim 1, wherein the metal sheet having the roughened matte finish has a static friction force of no more than 2 lbf.

5. The expandable catalyst support configuration according to claim 1, wherein the surface areas having the roughened matte finish have a surface roughness (Ra) within the range of 0.2 mm to 50 mm.

6. The expandable catalyst support configuration according to claim 1, wherein the spiral-wound metal sheet has the roughened matte finish on one side thereof.

7. The expandable catalyst support configuration according to claim 1, wherein the spiral-wound metal sheet has the roughened matte finish on both opposing sides thereof.

8. The expandable catalyst support configuration according to claim 6, wherein an area of at least 50% of one or both sides of the spiral-wound metal sheet have the roughened matte finish.

9. A reactor comprising:
an outer tube; and
an expandable catalyst support configuration according to claim 1 disposed within the outer tube, wherein the expansion tube having the roughened matte finish biases the expandable catalyst support towards the outer tube.

10. The reactor according to claim 9, wherein the reactor is configured to operate with a pressure gradient across the expandable catalyst support configuration within the range of 1.4 m/bar/in to 5 mbar/in.

11. The reactor according to claim 9,
wherein the reactor is configured such that the expandable catalyst support configuration has a static pull-out force within the range of 100 lb to 1000 lb.

12. A method of installing an expandable catalyst support configuration according to claim 1 into a reactor comprising an outer tube, the method comprising:
inserting the expandable catalyst support configuration into the outer tube of the reactor; and
pumping or blasting compressed gas into the expansion tube to unfurl the expansion tube pushing the expandable catalyst support outwards towards the outer tube.

13. The expandable catalyst support configuration according to claim 2, wherein the metal sheet having the roughened matte finish has a static friction force of no more than 2 lbf.

14. The expandable catalyst support configuration according to claim 3, wherein the metal sheet having the roughened matte finish has a static friction force of no more than 2 lbf.

15. The expandable catalyst support configuration according to claim 2, wherein the surface areas having the roughened matte finish have a surface roughness (Ra) within the range of 0.2 mm to 50 mm.

16. The expandable catalyst support configuration according to claim 3, wherein the surface areas having the roughened matte finish have a surface roughness (Ra) within the range of 0.2 mm to 50 mm.

17. The expandable catalyst support configuration according to claim 4, wherein the surface areas having the roughened matte finish have a surface roughness (Ra) within the range of 0.2 mm to 50 mm.

18. The expandable catalyst support configuration according to claim 2, wherein the spiral-wound metal sheet has the roughened matte finish on one side thereof.

19. The expandable catalyst support configuration according to claim 3, wherein the spiral-wound metal sheet has the roughened matte finish on one side thereof.

20. The expandable catalyst support configuration according to claim 4, wherein the spiral-wound metal sheet has the roughened matte finish on one side thereof.
